(19) United States
(12) Patent Application Publication
(10) Pub. No.: US 2021/0304221 A1
(43) Pub. Date: Sep. 30, 2021

(54) SYSTEM AND METHOD FOR DONATION TRACKING

(71) Applicants: Tim Oppenheim, Jonesboro, AR (US); Michael Patterson, Jonesboro, AR (US)

(72) Inventors: Tim Oppenheim, Jonesboro, AR (US); Michael Patterson, Jonesboro, AR (US)

(21) Appl. No.: 17/345,802

(22) Filed: Jun. 11, 2021

Related U.S. Application Data
(60) Provisional application No. 63/179,713, filed on Apr. 26, 2021.

(51) Int. Cl. G06Q 30/00; G06F 3/0482

(52) U.S. Cl. CPC G06Q 30/018; G06F 3/0482

(57) ABSTRACT

A system and method for tracking in-kind donations. The system provides a user interface for the user wishing to donate in-kind. The user interface provides a list of goods and services eligible for donations, wherein the goods and services are categorized based on the class or other parameters. Upon selecting a suitable category, a form can be presented on the user interface, wherein the form includes predefined fields. The system through the form can receive structured information about the goods or services being donated. The user interface may also allow a user to digitally verify the form. The system further provides an admin interface that allows tracking the transactions and preparing reports for statutory compliance.

### FIELD OF INVENTION

The present invention relates to a platform for tracking donations, and more particularly the present invention relates to a system and method for tracking non-monetary donations.

### BACKGROUND

Donation refers to something that is given for the charity. A donation can be a sum of money, goods, food, or a working hour, and like. Tracking monetary donations can be easy and software are available commercially to keep an account of monetary transactions. However, tracking non-monetary transactions is still challenging. Generally, crude physical records are maintained that are difficult to track and analyze. There could be several reasons for recording and tracking non-monetary transactions, such as regulatory filings. Thus, a long and unsolved desire is there for a platform that can help record and analyze transactions in a non-monetary donation.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for recording non-monetary transactions in donations.

It is another object of the present invention that the system and method permit statutory filings of the non-monetary transactions.

It is still another object of the present invention that the system and method allow sorting and analysis of non-monetary transactions.

It is yet another object of the present invention that the system reduces errors in the records.

It is a further object of the present invention that the system and method prevent undesired donations.

It is still a further object of the present invention that the system and method make the records maintenance process easier, faster, and legit.

In one aspect, disclosed is a system for record keeping of in-kind donations. The system provides a user interface for the user wishing to donate in-kind. The user interface provides a list of goods and services eligible for donations, wherein the goods and services are categorized based on the class or other parameters. Upon selection of a suitable category, a form can be presented on the user interface, wherein the form includes predefined fields. The disclosed system through the form can receive structured information about the goods or services being donated. The user interface may also allow a user to digitally verify the form.

In one case, the user interface and the system can provide for verification of the form, and any error can be presented to the user through the user interface for rectification. Upon rectification, the modified form can be verified.

In one aspect, the disclosed system can also provide an admin interface. Through the admin interface, the records received by the system from the users can be viewed. Moreover, analysis can be performed on the saved records and automated reports can be received on the admin interface.

These and other objects and advantages of the embodiments herein and the summary will become readily apparent from the following detailed description taken in conjunction with the accompanying drawings

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environment diagram showing the disclosed system connected to a user device and an admin device, according to an exemplary embodiment of the present invention.

FIG. 2 is an exemplary embodiment of a user interface showing the categories of goods and services for an in-kind donation, according to an exemplary embodiment of the present invention.

FIG. 3 shows an exemplary embodiment of a form with predefined fields and a counter button for increasing or decreasing a value, according to an exemplary embodiment of the present invention.

FIG. 4 is another exemplary embodiment of the interface showing a list of items for in-kind donation with options to increase or decrease the quantity of items using clickable counter buttons, and a value of the item, according to an exemplary embodiment of the present invention.

FIG. 5 is another exemplary embodiment of the interface providing a section of the form for date and signature to authorize the form, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

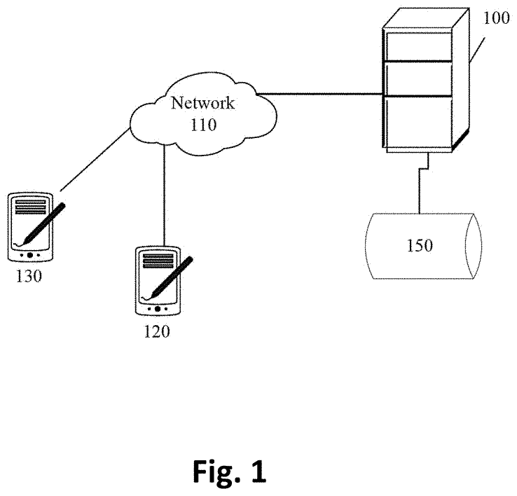

Disclosed is a platform to easily collect, report, and analyze in-kind donations for non-profit organizations. Referring to FIG. 1 which is an environmental diagram showing the disclosed system 100 having the platform for record keeping of in-kind donations. The system 100 can be seen connected to a user device 120 through a network 110. In one case, the network can be a wired or wireless network. For example, the wired networks may include Digital Subscriber Line (DSL), coaxial cable lines, or optical fiber lines. The wireless network may include Wi-Fi, Worldwide Interoperability for Microwave Access (WiMAX), an infrared channel or satellite band, cellular networks including 2G, 3G, 4G, 5G. the user device can be a computing device having a display, an input, and a network circuitry for connecting to the network 110. The user device can be a smartphone, tablet computer, workstations, laptops, and thin client, and like computing system known in the art.

The disclosed system 100 may also be connected to an admin device 130. The admin device can be a computing device having a display, an input, and a network circuitry for connecting to the network 110. The admin device can be a smartphone, tablet computer, workstations, laptops, and thin client, and like computing system known in the art. It is to be understood that FIG. 1 shows the user device and admin device for illustrator purposes only and it will be obvious that more than one user device and more than one admin device can be simultaneously connected to the disclosed system. Moreover, the user device can be connected to the system independent of the admin device and vice versa. Additionally, FIG. 1 shows the admin device and the user device connected to the system through a common network 110, however, those skilled in the art will recognize that the different admin device and user devices can be connected through different networks and a single user device or admin device can be connected through more than one network, without departing from the scope of the present invention.

FIG. 1 also shows a database 150 connected to the system 100. The database 150 can store the records, wherein the database can be any suitable database, such as SQL based database or any other structure database that can retrieve records based on a query. Moreover, the database may help organize and sort the records based on one or more predefined fields.

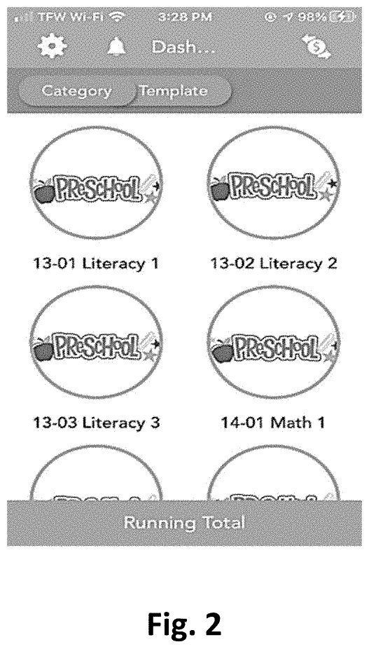

Referring to FIG. 2 which shows an exemplary embodiment of a user interface provided by the system on the user device for entering an item for an in-kind donation. The user interface can be provided as application software that can be installed on the user device 120. The application software can be developed for Android, iOS, and any other known operating platform for mobile devices. The application software can be made available through a distribution service provider, for example, Google Play operated and developed by Google and the app store by Apple. In addition to the application software, a website-based interface can also be provided through the world-wide-web. Similarly, the admin interface can also be provided by the same application software or different application software may be provided for the admin devices.

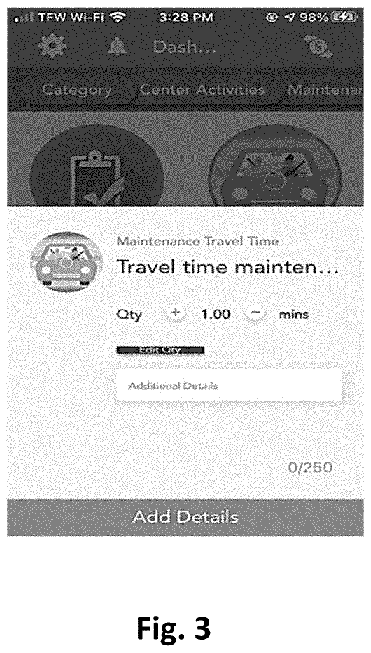

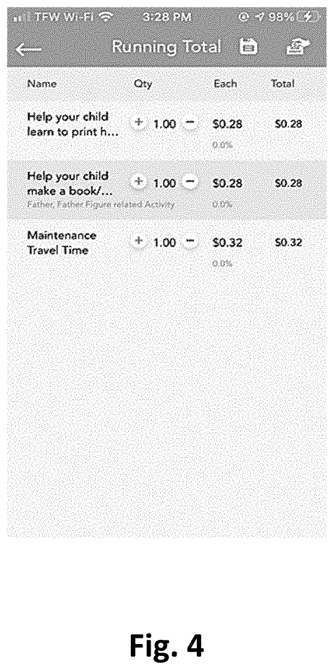

A user desire for in-kind donation can download the user interface on the user device as shown in FIG. 2. For example, time reading books, help in painting a classroom, time serving on a board, and like can be recorded through the provided user interface. The user interface can provide categories for the goods and services that can be accepted for the in-kind donation. The categories can have related subcategories, for example, the garment category can have subcategories of male, female, and children. The hierarchy in the categories can help sort the records for in-kind donations based on the item donated. Moreover, the categories can inform the user about the goods and services that can be donated and prevent the donation of prohibited goods or services. After the selection of the suitable category, the interface can provide a form for additional details of the item being donated. The term item includes any kind of acceptable goods, services, property, and like eligible for fthe in-kind donation. The form can include predefined fields for receiving details of the item. FIG. 3 shows a section of the form which shows the item selected for donation. The user can increase or decrease the quantity of the item using clickable counter buttons. Also, a free text entry box can be provided for additional details. Using the same form, the user can add more than one item. After adding all the items, a summary or list of items can be presented through the interface, as shown in FIG. 4. The user can modify certain fields in the summary section as well. For example, FIG. 4 shows the field Quantity and counter buttons are also provided to increase or decrease the value of the Quantity variable. A user can also enter details of the donation like particulars of the donation and photographs of the transaction.

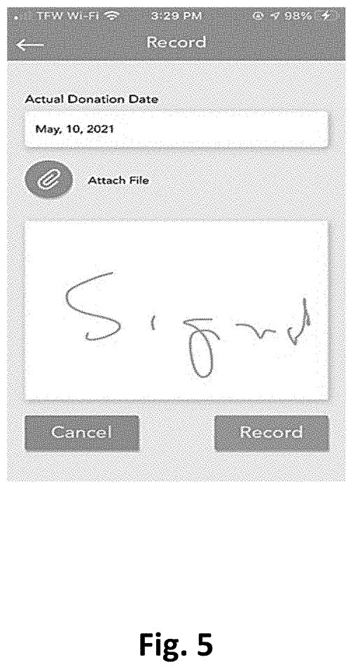

Referring to FIG. 5 shows the user interface for digitally signing the transaction. At end of the form can be provided a verification section. The date and time of the transaction can be automatically stamped by the user interface. Alternatively, an option, as shown in FIG. 5 can also be provided that allows that user to manually enter the date. Any error in the form can be displayed to the user. The user can correct the error and reverify the form. The interface may allow a user to digitally sign the transaction for authenticating the donation. The system can receive the transaction from the user interface. Any valid transaction can also be audited later, and any error can be rectified by sending the digital form indicating the error back to the user. The user can rectify the error and resubmit the form after verification. It is to be understood that any means of authentication other than a digital signature is within the scope of the present invention. The authorized transaction can be received by the disclosed platform. The disclosed platform can process and store the transactions in a database as records. The records can be queried, and analysis can also be made. The disclosed system can also provide an admin interface that allows analysis and preparing reports based on the number and types of transactions. Through the admin interface, any record can be reviewed, check for any errors, and can be approved or declined. The admin interface may allow correcting errors in the record or sending the record back to the user for rectification. The transactions can be audited in near real-time, and any wrong entry can be captured and corrected easily and quickly. For example, the working hours as an in-kind donation may be tallied in near real-time. The admin interface may allow performing analysis, sorting the records, and preparing reports.

The disclosed system can be used to track the non-federal share of federal grants. Grant-funded programs can be easily tracked and managed. Compliance and other regulatory reporting including federal compliance can be easily managed using the disclosed system. The disclosed system provides for capturing documentation and reporting it on time.

The disclosed system can be used by both organizations and individual users for recording and reporting transactions related to in-kind donations. A user can enter details of the donation like particulars of the donation and photographs of the transaction. The transactions can be records in a database which can allow preparing reports for statutory filings easily and quickly.

In one embodiment, a donor may be requested to sign the transaction, and such digital forms can be verified in near real-time, thus preventing incomplete forms and failed compliance. The user can be well informed about the goods that can be donated.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer-implemented method for tracking in-kind donations for statutory compliance, the method comprising the steps of:
providing a user interface on a user device, by a system, the user interface configured to:
present a list of categories of items eligible of an in-kind donation,
present pre-defined fields to receive the details of the items being donated, and
permit a user to verify a transaction related to the in-kind donation of the items;
providing an admin interface, on an admin device, by the system, the admin interface configured to:
review the transaction for any errors, and
prepare a report for statutory compliance.

2. The method according to claim 1, wherein the user interface further configured to:
present a form for digitally sign to verify the transaction.

3. The method according to claim 1, wherein the user interface is further configured to:
determine any error in the transaction;
present the error to the user for rectification; and
permit the user to reverify the corrected form.

4. The method according to claim 1, wherein the user interface further configured to:
associate clickable counter buttons to one or more of the pre-defined fields, wherein the clickable counter buttons can be clicked to increase or decrease a value of the associated field.

5. A computer-implemented method for tracking in-kind donations for statutory compliance, the method comprising the steps of:
providing a user interface on a user device, by a system, for receiving details of one or more items for in-kind donation;
providing, through the user interface, a list of categories of items eligible for an in-kind donation;
providing, through the user interface, pre-defined fields to receive detail of the one or more items being donated;
receiving, through the user interface, the detail of the one or more items;
verifying, through the user interface, the detail of the one or more items;
receiving a verification of a transaction of the in-kind donation of the one or more items, through the user interface;
providing an admin interface, on an admin device, by the system;
reviewing, through the admin interface, the transaction for any errors; and
preparing, through the admin interface, a report for statutory compliance.

6. The method according to claim 5, wherein the method further comprises the steps of:
determining, by the system, any error in the transaction;
presenting, through the user interface, the error for rectification; and
receiving, through the user interface, a corrected form.
